(19) United States
(12) Patent Application Publication
(10) Pub. No.: US 2013/0212305 A1
(43) Pub. Date: Aug. 15, 2013

(54) MULTIMEDIA PROJECTOR

(71) Applicants: XIAO-GANG YIN, Shenzhen City (CN); GUI-FU XIAO, Shenzhen City (CN); GUO-YI CHEN, Shenzhen City (CN)

(72) Inventors: XIAO-GANG YIN, Shenzhen City (CN); GUI-FU XIAO, Shenzhen City (CN); GUO-YI CHEN, Shenzhen City (CN)

(21) Appl. No.: 13/659,994

(22) Filed: Oct. 25, 2012

(30) Foreign Application Priority Data
Feb. 9, 2012 (CN) 201210028235.2

(51) Int. Cl. G06F 13/14

(52) U.S. Cl. 710/33

(57) ABSTRACT

A multimedia projector includes a local area network (LAN) port, a storage system, a video playing module, a file activation module, and a projection lens. The LAN port is coupled to a peripheral apparatus to receive videos and files from the peripheral apparatus. The storage system stores the videos and the files. The video playing module reads the videos from the storage system, and plays the videos. The file activation module reads the files from the storage system, and opens the files. The projection lens projects the videos and the files accordingly.

### BACKGROUND

1. Technical Field

The disclosure generally relates to projectors, and particularly to a multimedia projector.

2. Description of the Related Art

Projectors can be used in almost any situation, such as business negotiations, education, or home entertainment. However, the projector can only project images, and cannot play videos or open documents independently. In particular, it may be inconvenient for a user to manipulate the projector via computer peripheral equipment, such as a keyboard.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is an assembled view of a multimedia projector, according to an exemplary embodiment.

FIG. 2 is a block diagram illustrating of the multimedia projector as shown in FIG. 1.

### DETAILED DESCRIPTION

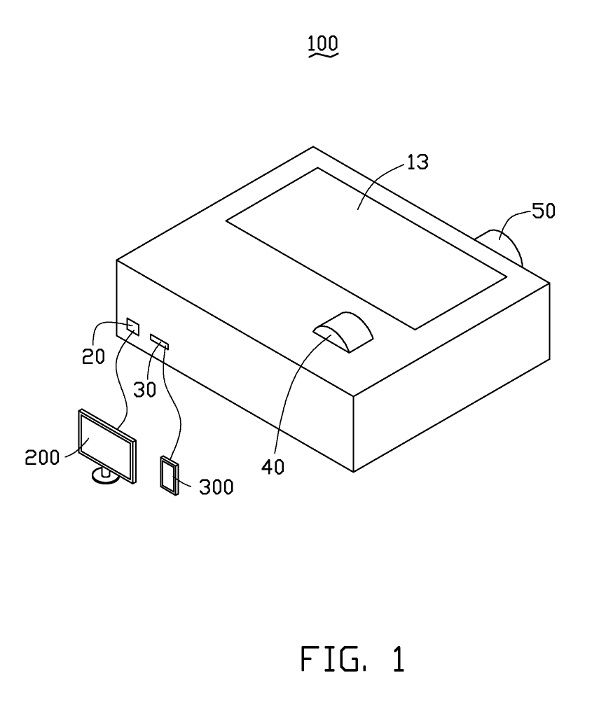

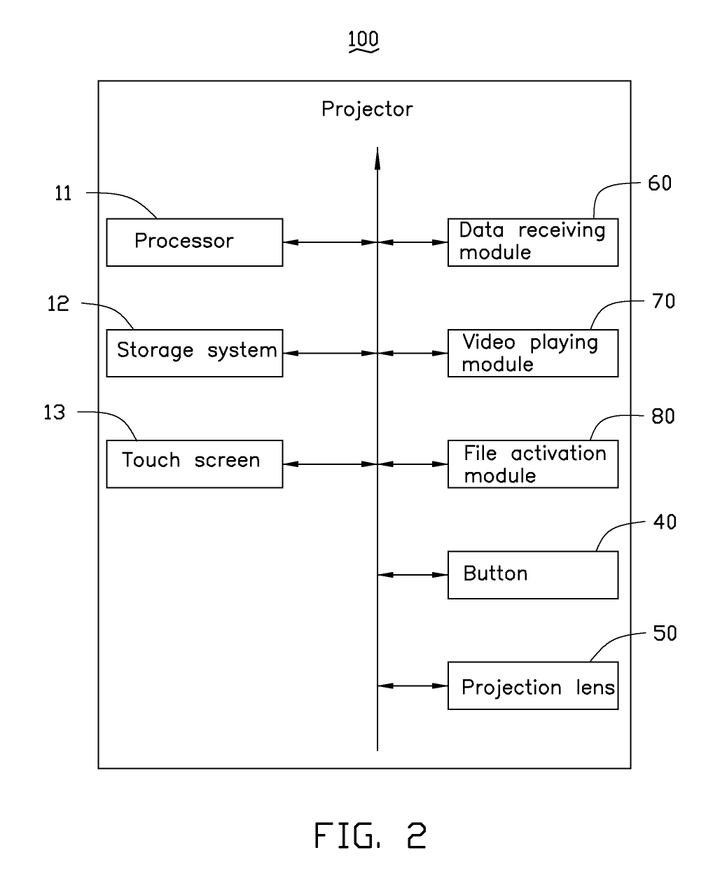

FIGS. 1-2 show an embodiment of a multimedia projector 100. The multimedia projector 100 includes a processor 11, a storage system 12, a touch screen 13, a local area network (LAN) port 20, a universal serial bus (USB) port 30, a button 40, and a projection lens 50. In one embodiment, the storage system 13 may be an internal storage system of the multimedia projector 100, such as a random access memory (RAM) for temporary storage of information, and/or a read only memory (ROM) for permanent storage of information. In some embodiments, the storage system 13 may also be an external storage system, such as an external hard disk drive, a storage card, or a data storage medium.

The multimedia projector 100 further includes a data receiving module 60, a video playing module 70, and a file activation module 80. The data receiving module 60, the video playing module 70, and the file activation module 80 may include a plurality of programs in the form of one or more computerized instructions stored in the storage system 12 and executed by the processor 11 to perform operations of the multimedia projector 100. In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules, and may be stored in any type of non-transitory computer-readable medium or other storage device. Some non-limiting examples of non-transitory computer-readable mediums include compact discs (CDs), digital versatile discs (DVDs), flash memory, and hard disk drives (HDD).

The LAN port 20 can be coupled to a peripheral apparatus 200 (e.g., personal computer) via interconnecting cables, for allowing the peripheral apparatus 200 to access the multimedia projector 100. Thus, the peripheral apparatus 200 can transmit videos, files or other data to the multimedia projector 100.

The data receiving module 60 receives the videos, the files or the other data from the peripheral apparatus 200 via the LAN port 20, and the videos, the files or the other data are stored in the storage system 12. In on embodiment, the data receiving module 60 is software named EASYLAN.

The USB port 30 can be coupled to a peripheral device 300 (e.g., mobile phone) via USB cables, for allowing the multimedia projector 100 to receive the videos, the files or the other data from the peripheral device 300, and store the videos, the files or the other data to the storage system 12.

The video playing module 70 reads the videos from the storage system 12, and plays the videos on the touch screen 13. In on embodiment, the video playing module 70 can play a plurality of video formats as known, such as MPEG4 format or WMV format.

The file activation module 80 reads the files from the storage system 12, and opens the files. In on embodiment, the file activation module 80 can open a plurality of document format as known, such as PPT format or PDF format.

Users can operate the videos and the files through the touch screen 13 or the button 40. For example, the touch screen 13 allows display of the videos and the files, and allows editing of the videos and the files by manipulations on the touch screen 13. Additionally, the users can press down or release (e.g., actuate) the button 40 to generate a command. The processor 11 is electronically connected to the button, for performing a corresponding action on the videos and the files according to the command. For example, when a double-click of the button 40 is performed, an active video is paused by the processor 11.

The projection lens 50 projects the videos and the files on a predetermined location to permit viewing of the videos and the files.

In summary, the multimedia projector 100 can store the videos, the files, and the other data in the storage system 12, and directly play or open the videos or the files via the video playing module 70 and the file activating module 80. Thus, the computer peripheral equipment, such as a keyboard or a mouse, is not needed. This is very convenient for the users to manipulate the multimedia projector 100.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A multimedia projector, comprising:
a local area network (LAN) port, the LAN port configured to be coupled to a peripheral apparatus for allowing the multimedia projector to receive videos and files from the peripheral apparatus;
a storage system storing the videos and the files;
a video playing module reading the videos from the storage system, and playing the videos;
a file activation module reading the files from the storage system, and opening the files; and
a projection lens projecting the videos and the files.

2. The multimedia projector as claimed in claim 1, further comprising a data receiving module receiving the videos and the files from the peripheral apparatus via the LAN port, and storing the videos and the files in the storage system.

3. The multimedia projector as claimed in claim 1, further comprising a universal serial bus (USB) port, the USB port is configured to be coupled to a peripheral device for allowing the multimedia projector to receive the videos and the files from the peripheral device.

4. The multimedia projector as claimed in claim 1, further comprising a touch screen allowing display of the videos and the files and allowing editing of the videos and the files by manipulations on the touch screen.

5. The multimedia projector as claimed in claim 1, further comprising a button that generates a command when the button is actuated.

6. The multimedia projector as claimed in claim 5, further comprising a processor electronically connected to the button, the processor performing a corresponding action on the videos and the files according to the command

7. A multimedia projector, comprising:
a local area network (LAN) port, the LAN port configured to be coupled to a peripheral apparatus for allowing the multimedia projector to receive videos and files from the peripheral apparatus;
a storage system storing the videos and the files;
a processor;
one or more programs stored in the storage system and executed by the processor, the one or more programs comprising:
a video playing module reading the videos from the storage system, and playing the videos; and
a file activation module reading the files from the storage system, and opening the files.

8. The multimedia projector as claimed in claim 7, further comprising a projection lens that projects the videos and the files.

9. The multimedia projector as claimed in claim 7, wherein the one or more programs further comprise a data receiving module that receives the videos and the files from the peripheral apparatus via the LAN port, and stores the videos and the files in the storage system.

10. The multimedia projector as claimed in claim 7, further comprising a universal serial bus (USB) port, the USB port is configured to be coupled to a peripheral device for allowing the multimedia projector to receive the videos and the files from the peripheral device.

11. The multimedia projector as claimed in claim 7, further comprising a touch screen allowing display of the videos and the files and allowing editing of the videos and the files by manipulations on the touch screen.

12. The multimedia projector as claimed in claim 7, further comprising a button that generates a command when the button is actuated, the processor performing a corresponding action on the videos and the files according to the command.
